(19) United States
(12) Patent Application Publication
(10) Pub. No.: US 2008/0056518 A1
(43) Pub. Date: Mar. 6, 2008

(54) System for and Method of Optimizing an Individual's Hearing Aid

(76) Inventors: Mark Burrows, Princeton, NJ (US); John Cronin, Jericho, VT (US); Nancy Edwards, Jericho, VT (US); Tushar Narsana, Naperville, IL (US); Steven A. Shaya, Highlands, NJ (US)

Correspondence Address: NORRIS MCLAUGHLIN & MARCUS, P.A., P O BOX 1018, SOMERVILLE, NJ, 08876, US

(21) Appl. No.: 11/570,472

(22) PCT Filed: Jun. 13, 2005
(86) PCT No.: PCT/US05/20826

§ 371 Date: Oct. 2, 2007

Related U.S. Application Data
(60) Provisional application No. 60/579,438, filed on Jun. 14, 2004.

(51) Int. Cl. H04R 25/00

(52) U.S. Cl. 381/314

(57) ABSTRACT

The present invention is a system for and method of adjusting hearing aids (130) by discrete frequency ranges (FIG. 3a); continual tuning and reprogramming of the hearing aid is accomplished in real time via iterations between a patient (with hearing aid in ear, 120) and an audiologist (131). A test tone or other sound is played and the patient gives feedback on the test tone's suitability (such as loudness). The hearing aid (130) is further tuned and reprogrammed accordingly as the sound is replayed and the patient (120) gives additional feedback. These steps continue until the patient (120) considers the hearing optimized, compensating for both the patient's hearing loss and individual preferences in the discrete frequency ranges. The following are twelve commonly tested frequency ranges: 125 Hz, 250 Hz, 750 Hz, 1000 Hz, 1500 Hz, 2000 Hz, 3000 Hz, 4000 Hz, 5000 Hz, 6000 Hz, 8000 Hz, and 10,000 Hz.

### CROSS REFERENCE TO RELATED APPLICATION

This application claims the benefit of U.S. Provisional Application No. 60/579,438 filed Jun. 14, 2004, assigned to the assignee of this application and incorporated by reference herein.

### FIELD OF THE INVENTION

The present invention relates to hearing aids, specifically to a system for and method of adjusting hearing aids by discrete frequency range; continual tuning and reprogramming of the hearing aid is accomplished in real time via iterations between a patient (with hearing aid in ear) and an audiologist.

### BACKGROUND OF THE INVENTION

About two million hearing aids are sold annually in the U.S., generating $2.6 billion in revenue. Although 28 million Americans are hearing impaired, but only six million use hearing aids. Year after year, market penetration has increased little, making it apparent that factors other than patient need have inhibited market penetration. Central among these factors is the product-centric (as opposed to patient-centric) approach that the hearing aid industry has taken to fitting hearing aids. Hearing aid manufacturers concentrate marketing efforts almost solely on improving their devices, most notably with digital signal processing, while other patient needs and preferences are virtually ignored. Resources have not gone to improving the consequently ponderous process which patients face in purchasing, using, and maintaining a hearing aid.

In current practice, audiologists test a patient's hearing for volume by pitch, and then send test results to a hearing-aid manufacturer that programs the patient's hearing aid. The programmed hearing aid is subsequently shipped to the audiologist, who places it in the patient's ear, then tests the patient's hearing. When patients finally reach this stage in the laborious purchase process, trying out the hearing aid for the first time in the professional's office, the audiologist is unable to adjust the device's programming, let alone optimize that programming by tuning discrete frequency ranges to compensate for an individual's hearing loss and preferences in each of those discrete frequency ranges.

Furthermore, except for helping patients with performance/appearance tradeoffs in hearing aid model selection, audiologists can do little to help patients beyond adjusting volume by pitch. Other patient preferences are essentially ignored. Similarly not addressed are patients' needs regarding speech intelligibility, ambient noise in real-world settings (such as restaurants, theaters, conference rooms) that interfere with hearing conversations, and the impact of an individual patient's psychological makeup on the hearing-improvement process (most notably.

Consequently, patient dissatisfaction abounds: twenty percent of patients return their hearing aids for refunds, while the rest get by with diminished hearing-aid performance, and thus diminished quality of life. Clearly, a digital signal processor (DSP) is capable of being programmed at professionals' offices, interactively and in real time with patients. Conceptually, such programming is the audiologist's version of the optometrist's standard eyeglass-fitting procedure, i.e., asking patients as to the clarity of eye charts, adjusting focal correction, then repeating these steps until the focal correction is optimized. The optimal correction, called a prescription, is then applied to corrective lenses for that individual patient.

U.S. Pat. No. 6,201,875, incorporated by reference herein, describes a method of fitting a hearing compensation device that includes selecting a plurality of loudness levels for a plurality of frequency ranges and comparing each loudness level for each frequency for perceived sameness. The loudness levels may then be adjusted as needed to achieve perceived sameness across the frequency spectrum. A gain curve for each frequency is calculated from the selected plurality of loudness levels. With hearing aid in ear, patients sit at a computer or similar graphical-user interface and respond to loudness of tones in each of twelve frequency ranges. The hearing aid itself emits these test tones in one frequency range at a time; patients adjust the volume to their individual preference. This process is repeated for all twelve frequency ranges; results are sent with the hearing aid to its manufacturer for programming. The programmed hearing aid is shipped back to the audiologist.

U.S. Pat. No. 6,240,193, incorporated by reference herein, further teaches that to overcome the problems associated with an audiometer apparatus that either employs headphones or a generic device that fits into the ear to test for hearing loss, a fitting system employs a programmable hearing aid to be worn by the individual as the means of generating tones used to assess the hearing loss.”

While the two referenced prior art patents take the first step toward optimizing the actual hearing aid the patient will use in real time, they do not simplify the cumbersome purchase process by enabling audiologists to program a hearing aid on a patient's first diagnostic visit.

Another problem with the prior art is that it does not provide real-time, audiologist/patient interactivity in fine-tuning a hearing aid's programming in each frequency range.

Yet another problem with the prior art is that it does not address patients' individual rehabilitation determinants, such as speech intelligibility, ambient noise from real-world environments (such as restaurants, theaters, conference rooms) that interfere with hearing conversations, or the psychological makeup and preferences of the individual.

### SUMMARY OF THE INVENTION

It is therefore an object of the present invention to simplify the hearing aid purchase process, while addressing patients' related needs and preferences, in order to appeal to the mass market.

It is another object of this invention to improve hearing aid performance and patient satisfaction by providing real-time interactivity between audiologist and patient in tuning the hearing aid in each frequency range, repeating the process until the patient considers it optimized.

It is yet another object of this invention to address patients' individual rehabilitation needs, such as speech intelligibility, ambient noise from real-world environments (such as restaurants, theaters, conference rooms) that interfere with hearing conversations, and the psychological makeup and preferences of the individual.

Accordingly, the present invention is a simultaneous hearing test and hearing aid tuning and programming system and method that uses an individual patient's actual hearing aid in the patient's ear. Audiologists and patients interact in real time as the audiologist sends a test tone or other sound, such as a given volume in a single frequency range, then asks the patient as to the test tone's suitability (such as loudness). The hearing aid is further tuned and reprogrammed accordingly as the sound is replayed and the patient gives additional feedback. These steps continue until the patient considers the hearing aid optimized to his or her satisfaction and preferences. The optimal loudness for the frequency is programmed on the spot into the hearing aid via a series of modulated high-frequency sound waves, e.g., waves above 20 kHz, or via other wired or wireless device emanating from the audiologist's tone generator, and is then received and decoded by the hearing aid's DSP. The process is repeated for each of a set number (typically twelve) of frequency ranges. Further testing and programming similarly administered addresses patients' rehabilitation needs, such as compensating for ambient noises in day-to-day settings that interfere with hearing conversations.

Thus, the present invention provides a method for real time dynamic programming of a hearing aid:

collecting frequency versus amplitude hearing profile data for an individual using a hearing test;

computing digital signal processor (“DSP”) correction factors based on the frequency versus amplitude data;

programming the hearing aid (e.g. via a wireless or wired interface) with the DSP correction factors;

performing the hearing test at least a second time on the individual and collecting at least a second set of frequency versus amplitude hearing profile data;

generating at least a second set of DSP correction factors based on the at least second set of frequency versus amplitude data; and

programming the hearing aid with the at least second of DSP correction factors.

In a further embodiment of the method, the generating of the at least second set of DPS corrections factors includes consideration of at least one user specific needs (e.g. speech intelligibility) category.

In a further embodiment, the method includes storing the DSP correction factors at at least one of a local memory or a remote memory accessible over a network data communications interface.

Thus, the present invention further provides for a real time dynamically programmable hearing aid comprising:

a controller including a processor and a memory, wherein the processor is coupled to a microphone, a speaker and a data signal communications (e.g., wired or wireless) interface;

wherein the processor stores in the memory, in substantially real time, digital signal processor (“DSP”) correction factors received at the interface, and wherein the processor processes audio input signals provided from the microphone using the DSP correction factors to generate DSP modified audio input signals and supplies the DSP modified audio input signals to the speaker.

In a further embodiment of the hearing aid, the at least second set of DPS corrections factors includes compensation based on at least one user specific needs (e.g. speech intelligibility) category.

### BRIEF DESCRIPTION OF THE DRAWINGS

Other objects and advantages of the present invention will be apparent from the following detailed description of the presently preferred embodiments, which description should be considered in conjunction with the accompanying drawings in which like references indicate similar elements and in which:

FIG. 1 is a diagram of an audiological testing system that links remote databases and programmable hearing aids to test hearing and to program hearing aids in real time.

FIG. 2 is a method of testing patients' hearing and programming their hearing aids using the audiological testing system that links remote databases and programmable hearing aids to test hearing and to program hearing aids in real time.

FIG. 3A is an example of the data stored on the audiological testing and central computer hearing system.

FIG. 3B is a graph illustrating the impact of patient characteristics and preferences on achieved standard hearing.

### DESCRIPTION OF THE INVENTION

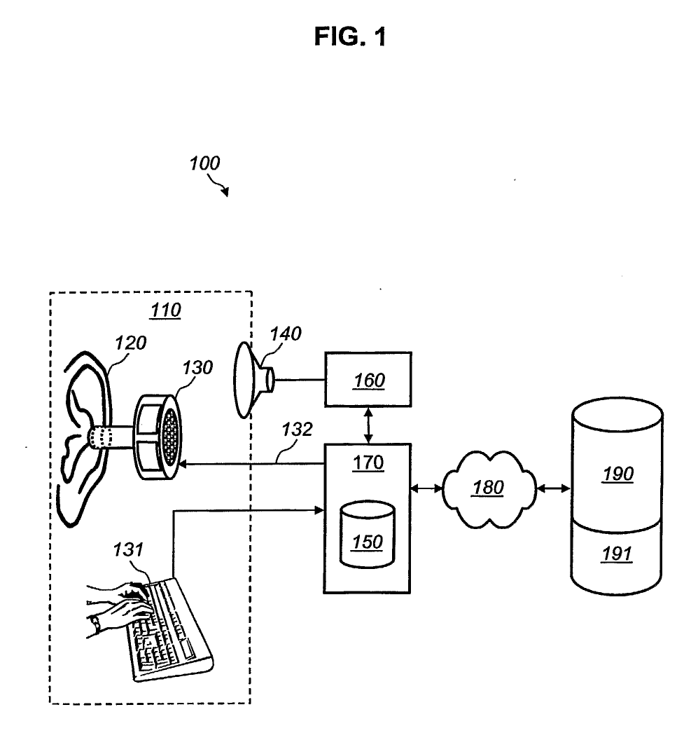

FIG. 1 shows a diagram of an audiological testing system 100 that links remote databases and programmable hearing aids to test hearing and to program hearing aids in real time. System 100 includes an audiological sound room 110 enclosing a patient 120, a hearing aid 130, a patient input device 131, and a sound system 140; an audiological testing PC 170 that contains an amount of memory 150 and that is connected to hearing aid 130 through a hearing aid connection 132 and is also connected to patient input device 131; a sound simulator 160 that is connected to both audiological testing PC 170 and sound system 140; and a central hearing computer system 190 that contains a quantity of user data 191 and that connects to audiological testing PC 170 through the Internet 180.

Audiological sound room 110 is a standard sound booth that is widely used by audiologists, and includes headphones and a window through which audiologists visually interact with patients. Patient 120 is enclosed within audiological sound room 110.

Audiological testing PC 170 is a personal computer or comparable computer that has a display, a keyboard, memory 150 (such as disk drives, hard drives, RAM, ROM), a CPU, a modem and/or high-speed Internet/network connection, and any associated electronics. The programs that execute many of the steps of method of the present invention are stored on audiological testing PC 170 and reside in memory 150.

Also connected to audiological testing PC 170 is sound simulator 160. Sound simulator 160 can be, for example, a sound card capable of playing sounds to drive a conventional sound system 140. Audiological testing PC 170 programs store any of a variety of sounds and speech as “.wav” files that can be transferred from memory 150 to sound simulator 160 to sound system 140. Sound system 140 is a high fidelity speaker system appropriately mounted in audiological sound room 110.

Central hearing computer system 190 is a central repository of all current audiological programs, audiological data such as National Institute of Standards and Technology (NIST) audiometer calibration standards, audiological research, sound “.wav” files, and speech and other sound simulations files. Central hearing computer system 190 centralizes information that allows all connected audiologists around the world to access continuously updated and refined audiologist test procedures, standards, and algorithms for programming and reprogramming DSP-based hearing aids, etc. Internet 180 or a comparable network connects central hearing computer system 190 to audiological testing PC 170.

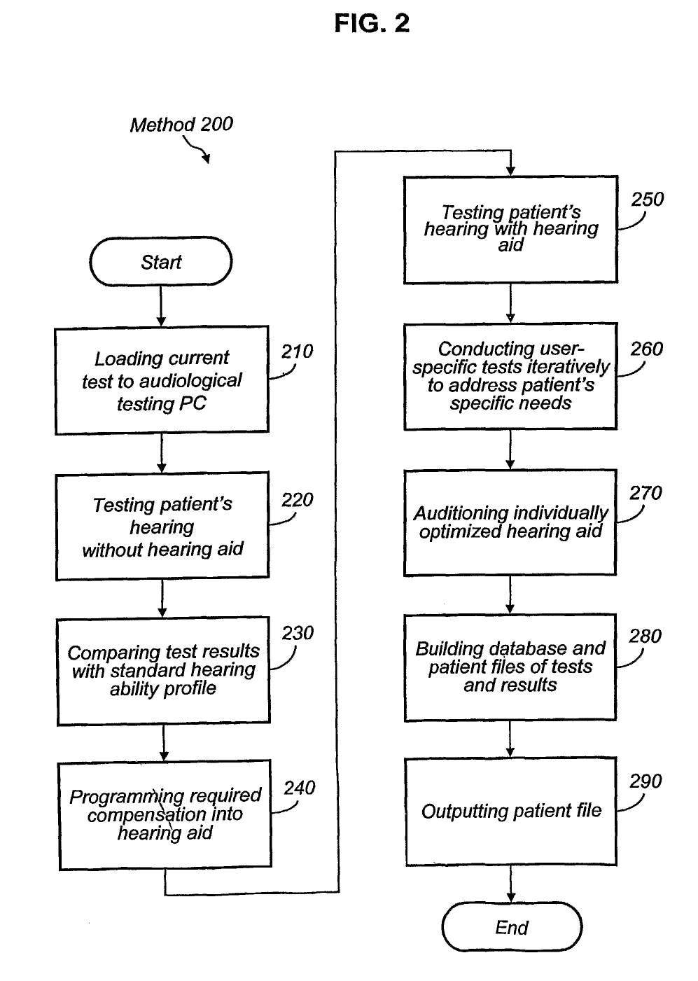

User data 191 is a memory region of central hearing computer system 190 that stores data about the user such as demographic information (age, name, date of birth, etc.) User data 191 also includes users' actual responses to the “first-pass correction gain” data, the “second-pass correction gain” data, and the “user-specific correction gain” data, as is explained in more detail with reference to FIG. 2. The program running on audiological tester PC 170 performs the step of uploading the test results to this database.

Hearing aid 130 is a programmable hearing aid that fits into patient 120's ear, and may include two separate devices for testing each ear independently as well as binaural responses. Hearing aid 130 is any one of a number of common digital signal processing (DSP) hearing aids, such as those described in U.S. Pat. No. 6,240,193, incorporated by reference herein, which describes both DSP hearing aid 130 and a serial interface for a programmable hearing aid. Hearing aid 130 can have one or more connector contacts (not shown) for programming the DSP. One such connector is explained below.

Hearing aid connection 132 is a connector to hearing aid 130, such as in U.S. Pat. No. 6,319,020, incorporated by reference herein. This invention, which is a device for coupling a programming connector to a programmable hearing aid, comprises an electrode coupled to a corresponding conductor of the programming connector, wherein the electrode is biased to maintain contact with a conductive surface in the hearing aid. The coupling device is adapted to engage within a receiver module of a completely-in-canal (CIC) hearing device. Data from an outside source, such as a computer, can thereby be easily transferred through hearing aid connection 132 to DSP circuitry within hearing aid 130. In a preferred embodiment, the hearing aid connection 132 includes a wireless signal receiver, such as a radio frequency or infrared receiver.

Patient input device 131 is any of a type of device that can input commands and data to a PC, such as keyboard, a specialized keyboard device, a mouse, a bank of switches, etc. Patient input device 131 is connected to audiological testing PC 170 by appropriate cabling or coupled to the PC 170 using a conventional wireless communications interface included at each of the PC 170 and the device 131. An output device from audiological testing PC 170 may also be available to the patient.

System 100 operates as follows: patient 120 sits in audiological sound room 110 and listens to tones stored in memory 150 of audiological testing PC 170 that are processed through sound simulator 160 and played by sound system 140. Patient 120 uses patient input device 131 to provide feedback to audiological testing PC 170 as to the comparative audibility of the tones. Programming based on the provided feedback is transmitted to hearing aid 130 through hearing aid connection 132. The testing process is repeated with hearing aid 130 in patient 120's ear, progressing through as many iterations as patient 120 feels is necessary to optimize the performance of hearing aid 130. Once performance is optimized, audiological testing PC 170 builds a database of test results that are stored in memory 150 and transmitted to central hearing computer system 190, where the test results are stored in user data 191.

FIG. 2 is a flow chart of a method 200 of testing patients' hearing and programming their hearing aids using audiological testing system 100 that links remote databases and programmable hearing aids to test hearing and to program hearing aids in real time. By doing so, this invention improves hearing aid performance and patient satisfaction by providing real-time interactivity between audiologist and patient in fine-tuning the hearing aid in each frequency range, repeating the process until the patient considers it optimized. Method 200 includes the following steps:

Step 210: Loading Current Test to Audiological Testing PC

In this step, an audiologist runs an audiological test program on audiological testing PC 170. Prior to running the test, audiological testing PC 170 automatically connects to Internet 180 or a comparable network, which in turn connects to central hearing computer system 190 to download current audiological programs, audiological data such as ANSI audiometer calibration standards, audiological research, sound “.wav” files, and speech and other sound simulation files.

Step 220: Testing Patient's Hearing Without Hearing Aid

In this step, the audiologist performs a standard hearing aid test of various tones (frequencies) at various amplitudes upon patient 120. Such tests are currently performed at audiological testing centers. Patient 120 sits at a computer or similar graphical user interface, responding to loudness of tones in each of the frequency ranges, adjusting the volume of the tones to his or her individual preference. Patient 120 selects a plurality of loudness levels for a plurality of frequency ranges and compares them for perceived sameness across the frequency spectrum, adjusting the loudness levels as necessary. The testing program calculates a gain curve for each frequency from the selected plurality of loudness levels.

To perform this test, sound signals representative of predetermined sounds are sent from audiological testing PC 170 through sound simulator 160 to sound system 140 in audiological booth 110, where patient 120, without hearing aid 130 in his or her ear, hears the predetermined sounds. Patient 120 responds via patient input device 131, which transmits data to audiological testing PC 170. The data is stored in memory 150 and is subsequently available to the audiologist and to other stakeholders for reference and analysis.

Step 230: Comparing Test Results with Standard Hearing Ability Profile

In this step, the results of the hearing test conducted in step 220 are compared with standard hearing ability data (stored in memory 150 of audiological testing PC 170) to determine the gain adjustment needed (if any) at particular frequencies and amplitudes. The comparison is performed via a computer algorithm that compares a particular test result at a given frequency and amplitude with the expected result and corrects by calculating a “first-pass correction gain.” The results of the test and the first-pass correction gain for each of the frequency vs. amplitude comparisons are stored in memory 150 of audiological testing PC 170.

Step 240: Programming Required Compensation into Hearing Aid

In this step, the first-pass correction gain factors are sent from audiological testing PC 170 to programmable hearing aid 130 via electrical hearing aid connection 132, thus programming hearing aid 130 specifically to the needs of patient 120, according to his or her hearing test results.

Step 250: Testing Patient's Hearing with Hearing Aid

In this step, patient 120 inserts hearing aid 130 (now programmed specific to his or her needs) in the ear to be tested. It should be noted that the audiological testing procedures easily isolate and test individual ears, so that the aforementioned process would be done first for one ear and then for the other.

The audiologist performs the standard hearing aid test of various tones (frequencies) at various amplitudes upon patient 120 (as described in step 220) for a second time.

The results of the second hearing test are compared with standard hearing ability data (stored in memory 150 of audiological testing PC 170) to determine the further gain adjustment needed (if any) at particular frequencies and amplitudes. The comparison is performed via a computer algorithm that compares a particular test result at a given frequency and amplitude with the expected result and corrects by calculating a “second-pass correction gain.” The results of the test and the second-pass correction gain for each of the frequency vs. amplitude comparisons are stored in memory 150 of audiological testing PC 170.

Step 260: Conducting User-Specific Tests Iteratively to Address Patient's Specific Needs

In this step, the audiologist conducts other tests based upon the specific needs of patient 120. For example, if patient 120 has high-frequency degradation (9000 Hz to 12,000 Hz), testing may focus on finer frequency ranges near the loss region (8500 Hz, 8600 Hz, 8700 Hz, 8800 Hz, 8900 Hz) to determine whether loss also exists at these regions. If there is less loss at these ranges than at 9000 Hz, this information can be used to fine tune gain factors and reprogram the DSP frequency range gain adjustments accordingly. Sound output and data collection and storage for these user-specific tests are as described in step 220.

The results of these user-specific test are compared with standard hearing ability data (stored in memory 150 of audiological testing PC 170) to determine the optimized gain adjustment needed (if any) at particular frequencies and amplitudes in order for patient 120 to consider the performance of hearing aid 130 optimal. The comparison is performed via a computer algorithm that compares a particular test result at a given frequency and amplitude with the expected result and corrects by calculating a “user-specific correction gain.” The results of the test and the user-specific correction gain for each of the frequency vs. amplitude comparisons are stored in memory 150 of audiological testing PC 170.

Step 270: Auditioning Individually Optimized Hearing Aid

In this step, the audiologist uses audiological testing PC 170, sound simulator 160, and sound system 140 to play a plurality of sound simulations representing real-world situations. Because patient 120 has had his or her user-specific gain factors programmed into hearing aid 130, he or she can hear how standard speech and music would sound assisted by the actual hearing aid he or she would wear. Patient 120 can then decide whether to purchase hearing aid 130, which has been individually optimized in real time.

Step 280: Building Database and Patient Files of Tests and Results

In this step, audiological testing PC 170 compiles the data saved to memory 150 in steps 220, 230, 250, and 260, as well as demographic information such as age, name, and date of birth, into a database.

Step 290: Outputting Patient File

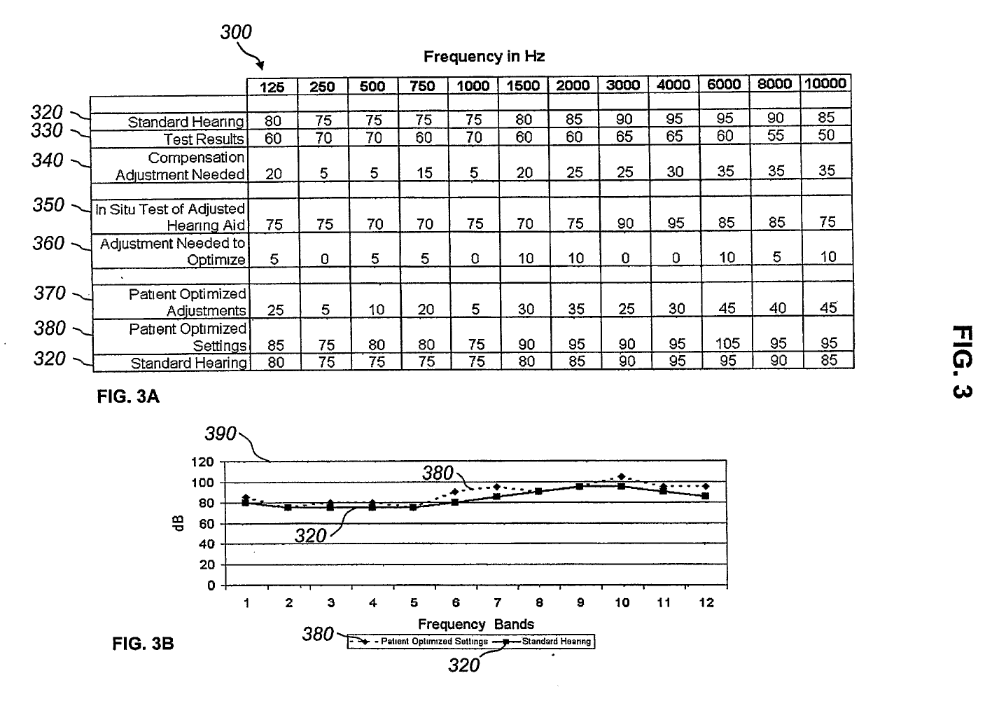

In this step, audiological testing PC 170 downloads the database compiled in step 280 to user data 191 via Internet 180. User data 191 is a portion of memory on central hearing computer system 190. An example of test data stored in user data 191 is shown in FIG. 3 below.

Method 200 solves problems in the prior art with concerning the inability to effectively address patients' individual rehabilitation determinants such as speech intelligibility, ambient noise from real-world environments (like restaurants, theaters, and conference rooms) and psychological makeup. User-specific tests described here enable audiologists to determine the hearing-improvement impact of effectively addressing these determinants.

Method 200 also simplifies the hearing aid patient's life by solving problems in the prior art created by the difficult and time-consuming process patients face in purchasing, using, and maintaining a hearing aid. A patient's needs and preferences are addressed, via real-time testing iterations with audiologists, enabling hearing aids to be programmed and fine tuned at the audiologist's facility until the patient considers it optimized. A patient can know exactly how his or her hearing will be improved by the hearing aid before he or she purchases it. Further, this method enables the manufacturer to reach beyond the current 6 million hearing aid wearers to the mass market of 22 million hearing-impaired Americans who do not use hearing aids.

FIG. 3A shows example hearing test results in a table 300 illustrating a plurality of ranges of frequency in Hz 310. Each range is assigned a volume level in decibels for standard hearing 320 and hearing test results 330, the difference between which is calculated as a compensation adjustment needed 340 from hearing aid 130, and which are programmed into hearing aid 130. With programmed hearing aid 130 in the ear of patient 120, in situ test of adjusted hearing aid 350 results are generated, then subtracted from standard hearing 320 values to calculate adjustment needed to optimize 360 values, which are also programmed into hearing aid 130. Patient-optimized adjustments 370 are added to hearing test results 330 to generate patient-optimized settings 380 to achieve patient 120's perception of standard hearing 320. FIG. 3B shows a graph 390 that visually compares patient-optimized settings 380 with standard hearing 320, illustrating the impact of an individual patient 120's characteristics and preferences on achieving standard hearing 320. As patient 120 is retested at future junctures, a new table 300 is created and the newly generated adjustments 370 are programmed into hearing aid 130.

Although preferred embodiments of the present invention have been described and illustrated, it will be apparent to those skilled in the art that various modifications may be made without departing from the principles of the invention.

What is claimed is:

1. A programming system for simultaneous testing hearing of an individual and tuning of a hearing aid of the individual, comprising
a sound generator generating a specific tone having a volume in a single frequency range;
the hearing aid being programmable and tuneable in response to the specific tone generated by the sound generator and in response to the individual; and wherein
an optimal loudness for the frequency range is programmed into the hearing aid.

2. The system of claim 1, wherein the optimal loudness for the frequency range is programmed into the hearing aid via a series of modulated high-frequency sound waves.

3. The system of claim 2, wherein the series of modulated high-frequency sound waves are above 20 kHz.

4. The system of claim 1, wherein the optimal loudness for the frequency range is programmed into the hearing aid via a wired interface device emanating from a tone generator and is received and decoded by a computing digital signal processor (DSP) of the hearing aid.

5. The system of claim 1, wherein the optimal loudness for the frequency range is programmed into the hearing aid via a wireless interface device emanating from a tone generator and is received and decoded by a computing digital signal processor (DSP) of the hearing aid.

6. A method for simultaneous testing hearing of an individual and tuning of a hearing aid of the individual, comprising the steps of:
collecting frequency versus amplitude hearing profile data for the individual using the hearing aid;
computing digital signal processor (“DSP”) correction factors based on the frequency versus amplitude data;
programming the hearing aid with the DSP correction factors.

7. The method of claim 6 further comprising the steps of
performing the hearing test at least a second time on the individual and collecting at least a second set of frequency versus amplitude hearing profile data;
generating at least a second set of DSP correction factors based on the at least second set of frequency versus amplitude data; and
programming the hearing aid with the at least second of DSP correction factors.

8. The method of claim 6, wherein the programming of the hearing aid is accomplished via a wireless interface with the DSP correction factors.

9. The method of claim 6, wherein the programming the hearing aid is accomplished via a wired interface with the DSP correction factors.

10. The method of claim 7, wherein the programming the hearing aid is accomplished with the at least second of DSP correction factors.

11. The method of claim 7, wherein the generating of the at least second set of DPS corrections factors includes consideration of at least one user specific needs (e.g. speech intelligibility) category.

12. The method of claim 11, wherein the at least one user specific need is speech intelligibility.

13. The method of claim 7, further comprising the step of
storing the DSP correction factors in a local memory.

14. The method of claim 13, further comprising the step of
storing the DSP correction factors in a remote memory accessible over a network data communications interface.

15. A real time dynamically programmable hearing aid comprising:
a controller including a processor and a memory, wherein the processor is coupled to a microphone, a speaker and a data signal communications (e.g., wired or wireless) interface; and wherein the processor stores in the memory, in substantially real time, digital signal processor (“DSP”) correction factors received at an interface.

16. The real time dynamically programmable hearing aid of claim 15, wherein the processor processes audio input signals provided from the microphone using the DSP correction factors to generate DSP modified audio input signals.

17. The real time dynamically programmable hearing aid of claim 16, wherein the processor supplies the DSP modified audio input signals to the speaker.

18. The real time dynamically programmable hearing aid of claim 15, wherein a second set of DPS corrections factors are received at the interface, the correction factors include compensation based on at least one user specific needs category.

19. The real time dynamically programmable hearing aid of claim 15, wherein the at least one user specific needs category is speech intelligibility.
